(19) United States
(12) Patent Application Publication
(10) Pub. No.: US 2018/0299413 A1
(43) Pub. Date: Oct. 18, 2018

(54) Fast Gas Chromatographic System used for the Rapid Analysis of Components Spanning a Wide Molecular Weight Range

(71) Applicant: Falcon Analytical Systems & Technology, Lewisburg, WV (US)

(72) Inventor: Ned Roques, Maxwelton, WV (US)

(73) Assignee: Falcon Analytical Systems & Technology, Lewisburg, WV (US)

(21) Appl. No.: 15/953,684

(22) Filed: Apr. 16, 2018

Related U.S. Application Data
(60) Provisional application No. 62/485,806, filed on Apr. 14, 2017.

(51) Int. Cl. G01N 30/12; G01N 30/60; G01N 30/46

(52) U.S. Cl. CPC G01N 30/12; G01N 30/6034; G01N 2030/025; G01N 2030/126; G01N 30/46

(57) ABSTRACT

A chromatographic system for rapid analysis of fluid components having a wide molecular range in a single sample is disclosed. A single isothermal oven having a switching valve controls the flow between a single column module and a dual column module. The single column module contains a shielded column with an input receiving components from a sample input and output to a detector via the valve. The dual column module contains two shielded columns wrapped adjacent one another on a single ring with separate inputs and outputs and in communication with one another and detectors through the switching valve. One or both columns in the dual column module can be heated and monitored with one or more sensor wires.

### FIELD OF THE INVENTION

The invention discloses a chromatographic system using two column modules, capable of the analysis of components having a wide range of molecular weights in a single sample.

### BACKGROUND OF THE INVENTION

There are times when analysts are faced with samples that contain components that span a very wide range of molecular weights making it difficult if not impossible to separate and quantify all components on a single chromatographic column and detector. If it is possible to separate all components of interest on a single column, it usually requires a very long (>60 m) capillary column, which directly equates to very long analysis times (30 minutes or longer).

Heartcutting techniques with reduced analysis times have been employed successfully for these types of analyses using multiple columns and column types along with switching valves and multiple detectors. These systems sequentially separate components into molecular weight “groups” which can be further directed (heart-cut) to other specific columns, via multi-port chromatographic valves, which are better suited to separate components in that specific molecular weight “group”. These systems are usually operated isothermally and are usually very large in order to accommodate the many columns, switching valves and detectors. Analysis times using these systems are still relatively slow (15 minutes or longer), and the total size and weight of the analyzer can approach that of a refrigerator.

Systems utilizing the above heartcutting techniques implement temperature programed ovens in an attempt to reduce analysis times and the required number of columns and detectors. However, these systems usually still require additional, isolated heated “zones” since the columns used to separate the components across the full range of molecular weights require specific, individual temperature programs for each column. Implementation of this system with a conventional gas chromatograph containing an “air bath” convection oven allows only one column to be temperature programmed at a time, thus requiring separate isothermal ovens for the other separation columns. This adds to the size and overall power consumption of the instrument and still presents a non-ideal analysis cycle time due to the isothermal conditions of the columns that are not temperature programmed.

### SUMMARY OF THE INVENTION

A chromatographic system for rapid analysis of fluid components having a wide molecular range in a single sample is disclosed. The system contains multiple sheathed columns, a single isothermal oven, and at least one detector. The timing of the system is controlled by a software microprocessor. The columns predetermine retention times, each of which can be different to enable the separation of a wide range of components. The fluid communication is through tubing having flow restrictors.

The isothermal oven contains a sample inlet; a switching valve having multiple ports and the ability to switch from an active state to an inactive state; fluid communication members; a sample loop; and a carrier gas inlet. The switching valve controls the fluid flow between a first column module, the sample loop, a second column module, a first detector module, and a second detector module.

The sample loop retains a portion of the sample between a first column module and a second column module for a predetermined period of time, with transfer between the columns module being controlled by the switching valve.

A single column module, containing only a single column, has one inlet port in fluid communication with the single column and the sample inlet; and an outlet port in fluid communication with the single column and the switching valve.

A dual column module, containing dual columns, has a first column and a second column, both wound on the same ring adjacent one another. The dual column module has two inlet ports and two outlet ports, namely a first inlet port and first outlet port and a second inlet port and second outlet port. Each of the first inlet port and first outlet port is in fluid communication with the first column and the switching valve. The second inlet port is in fluid communication with the second column and the switching valve, and the second outlet port is in fluid communication with the second column and the second detector module. One or both of the columns within the dual column module can be actively heated or one column can be actively heated, passively heating the adjacent column. A sensor wire can be placed adjacent one or both of the columns.

A first detector module and a second detector module each contain a detector that senses the presence of the individual components leaving the columns. Both detector modules are in fluid communication with the switching valve and at least one of the columns.

The system further contains two carrier gas inputs, one at the sample inlet and another at one of the switching valve ports in the isothermal oven. The carrier gas input into the switching valve port enables transfer of the components to the second column in the dual column module.

To initiate the analysis of components having a wide range of molecular weights a multi-port switching valve in an isothermal oven is placed in an idle state and the sample is placed in a heated sample inlet having a carrier gas, thus vaporizing the sample. The sample is transferred through a fluid communication member to an inlet port of a cool single column within a single column module for elution. After elution the sample is transferred to the single column outlet port, with a portion of said sample remaining in the single column. From the single column outlet port the sample is transferred to a first port in the switching valve and then on to a sample loop. The switching valve is then placed in an active state and the remaining portion of the sample in the single column is transferred, through the outlet port and the switching valve, to a first detector module. Once the sample transfer to the first detector module is completed, the switching valve is placed back in the idle state and the sample within the sample loop is transferred to a dual column module containing dual columns, a first column and a second column. The sample from the sample loop is initially transferred to the first column within the dual column module. The switching valve is changed to an active state to transfer permanent gases to the second column of the dual column module, and then to an idle state and heating the dual columns to complete elution. The components in the dual columns are transferred to detector modules based on the components and the dual columns are heated to clean out any residual material.

### BRIEF DESCRIPTION OF THE DRAWINGS

The invention will be described in conjunction with the accompanying drawings, in which:

FIG. 1 is a plan view of the chromatograph in the idle state in accordance with the invention;

FIG. 2 is a plan view of the chromatograph in the idle state in accordance with the invention;

FIG. 3 is a perspective view of the dual columns wound as though onto a ring on a ring support in accordance with the invention;

FIG. 4 is a side view of a method of wrapping the columns on a ring in accordance with the invention;

FIG. 5 is a top view of another method of wrapping the columns on a ring in accordance with the invention;

FIG. 6 is a perspective view of a ring, without columns, placed on a ring support in accordance with the invention; and

FIG. 7 is a perspective view of dual, adjacent columns illustrating the sensor wire in accordance with the invention.

### DESCRIPTION OF THE INVENTION

### Definitions

As used herein the term “column” shall include the column capillary, surrounding insulation or sheathing, and optional sensor wire. The sheathing material is dependent upon the end purpose, such as electrical insulation or heat retention, and will be known in the art.

As used herein the term “low-retentive column” shall refer to any capillary or micro packed column capable of separating compounds in the molecular weight range greater than ˜n-C10 and includes columns such as 152 4 m, MXT-1, 320 um ID, 0.2 um df (From Restek, for the separation of ˜n-C5 to n-C44)

As used herein the term “mid-retentive column” shall refer to any capillary or micro packed column capable of separating compounds in the molecular weight range of ethane (C2) to approximately dodecane (n-C12), and includes the porous polymer columns, such as MXT Q-bond, QS-bond, S-bond, U-bond and also alumina, silica and carbon based plot columns.

As used herein the term “high-retentive column” shall refer to any capillary or micro packed column capable of separating permanent gas compounds such as helium, hydrogen, oxygen, nitrogen, methane, carbon dioxide and carbon monoxide and includes columns such as the ShinCarbon micro-packed column as well as molecular sieve 13X and 5A.

It should be noted that the reference to mid and high retentive columns herein is strictly for clarity of explanation and is in no way a limitation. The process described herein is applicable for any column placed within any module in a physical arrangement as will be known in the art. The retention times on each of the columns for any given component is highly variable depending on how the user sets up the column temperature program rate and carrier gas pressure. Using ‘retention’ (i.e. highly retentive, mid retentive, low retentive) to describe the different column types relates directly to the amount of time it takes for any given component to elute from a column at a fixed temperature. The more time it takes for elution, the higher the retentive nature of the column.

As is well known in the industry, the manufacturing of a column is a very specific and time consuming process with only a few companies supplying the industry. Currently Restek makes the stainless steel capillary columns having sufficient coating variety and internal diameters that applicant uses in the disclosed process. The Restek columns provide the criteria for optimal results and any column meeting the desired criteria, regardless of manufacturer, can be used.

The movement of the sample within the system is controlled by software within a microprocessor based on either time or hardware. The time based control is programmed into the software by the user based on either current or prior scouting runs. Once the timing is determined for any given application it should remain constant and not need updating unless a variable is changed by the user, such as the temperature program rate of a column module or the carrier gas pressure. In some systems, sensors can be used to determine the completion of a step.

The invention described herein remedies the problems of slow analysis times, large instrument size, high power consumption, and overly complex plumbing schemes of commercially available instrumentation when analyzing samples that contain a very broad molecular weight distribution (hydrogen to approximately n-C44, tetratetracontane). The system of the present invention needs only a single injection of sample to perform a full analysis as opposed to some existing systems that require multiple injections to analyze the entire range of components. The invention utilizes the general concepts as described in U.S. Pat. No. 8,336,366, “Trans-configurable Modular Chromatographic Assembly” as well as U.S. Pat. No. 8,414,832, “Fast Micro Gas Chromatograph System” as the basis for a new, unique chromatographic system.

The analysis system 100 is comprised broadly of a single sample processing module 102, a first detector module 130, a second detector module 140, a single column module 150, and a dual column module 160. Sample processing module 102 is comprised of a sample inlet, one chromatographic switching valve 220, and a sample loop 240 all residing inside an isothermal oven 104. The isothermal oven 104 within sample processing module 102 is connected to the column modules 150 and 160 via inlet and outlet ports 202, 204, 206, 208, 212, and 214. The isothermal oven 104 of single sample processing module 102 and the column modules 150 and 160 are in fluid communication with at least one of the detector modules 130 and 140. Each of the first detector module 130, second detector module 140, sample processing module 102, single column module 150, and dual column module 160 has its own separate circuit board and microprocessor (not illustrated) and operates independently of each other. System wide coordination of all modules is performed by a central control board (not illustrated) containing its own microprocessor (not illustrated). The software used to acquire data from the system and download set point parameters (system pressures, column temperature programs, pressure programs, isothermal oven set points, and valve timings) to the system is available commercially from ChromPerfect Software.

The detectors used within first detector module 130 and second detector module 140 can be the same or any applicable combination of detectors. Examples of detectors that can be use are a Flame Ionization Detector (FID), Flame Photometric Detector (FPD), Thermal Conductivity Detector (TCD), Dielectric Barrier Discharge (DBD), Helium Ionization Detector (HID), Electron Capture Detector (ECD), Vacuum Ultraviolet Detector (VUV), Mass Spectrometer Detector (MSD), Nitrogen Phosphorus Detector (NPD), Pulsed Flame Photometric Detector (PFPD) or Sulfur Chemiluminescent Detector (SCD).

This choice of detectors depends on the application and the components that need to be analyzed. There can be many combinations of detectors and columns and would be up to the application engineer to determine the best configuration. To accurately separate the different levels, two applicable detectors are required.

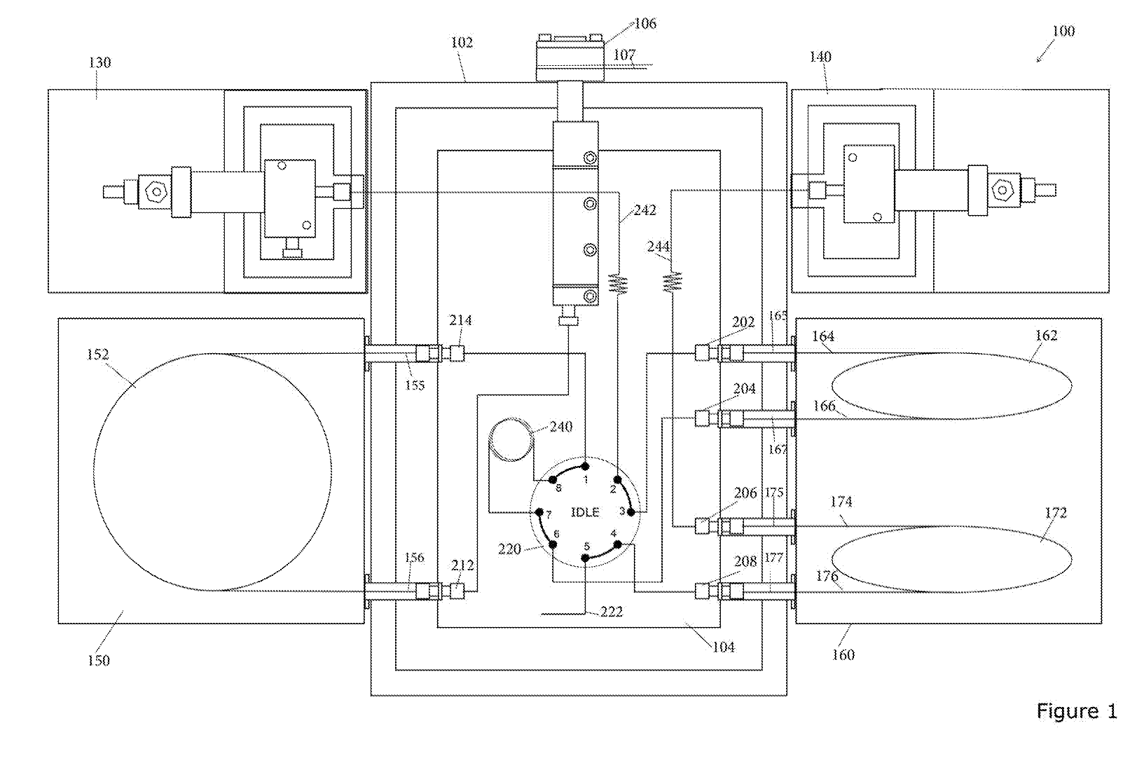

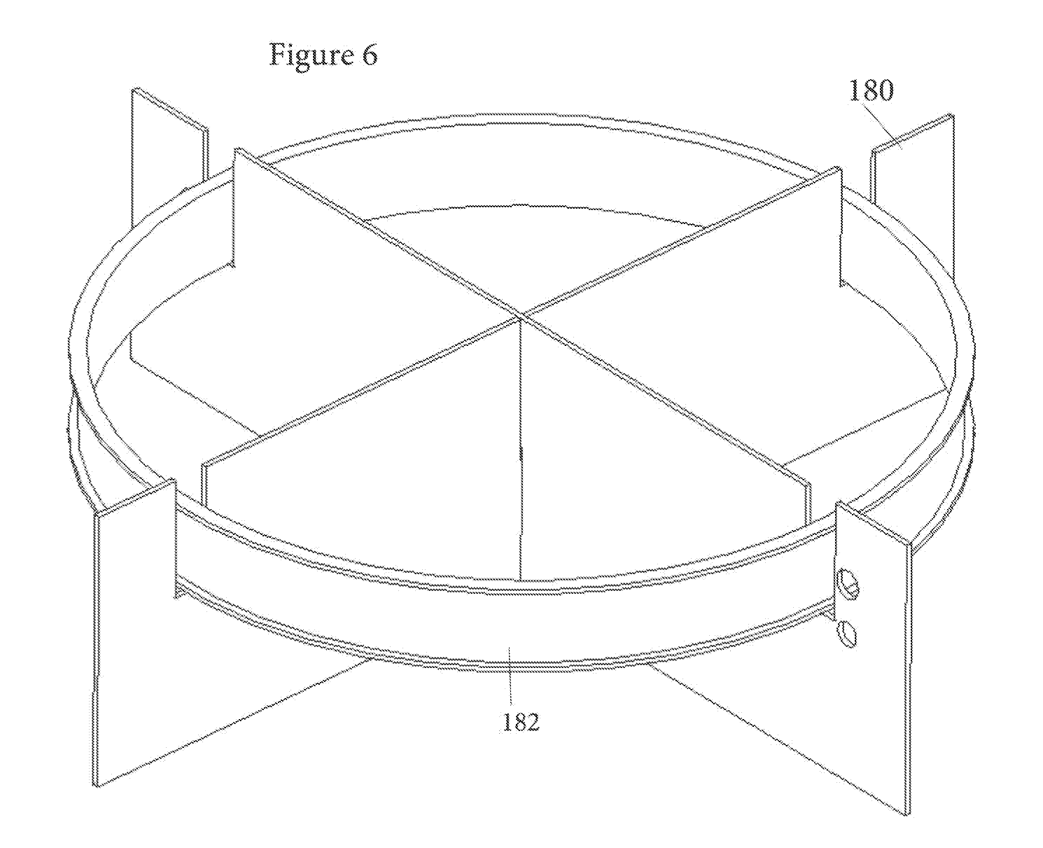

Even though the system is described as having two column modules, it contains three actual separation columns which will be described below. Single column module 150, as shown in FIG. 1, contains a single column 152 having a length of column material up to 20 m long wrapped on a support ring 182 contained within a ring support 180 (FIG. 6) as generally described in U.S. Pat. No. 8,414,832. The column material used for single column 152 is the least retentive of the three columns and is used to separate components from about n-C5 to n-C44 in molecular weight. Dual column module 160 contains a first column 162 and a second column 172, each column having a length of column material up to 10 m in length also on the single ring 182.

The column capillaries are sheathed with a fiberglass coating with the exception of the bare capillary column ends 156, 155, 165, 167, 175, and 177 inlet and outlet ports 212, 214, 202, 204, 206, and 208. The sheathing in most embodiments is predominately electrical insulation, or sheathing, to prevent adjacent coils from shorting one another out and to maintain the sensor wire adjacent the capillary. The components identified as inlet and outlet ports 212, 214, 202, 204, 206, and 208 are physically pneumatic unions that seal the column on one side and the transfer tubing on the other with a small tapered ferrule and nuts. The capillary column ends 156, 155, 165, 167, 175, and 177 are the sheath free ends of the capillary column that protrude into the connector unions which receive the ferrule.

For ease of differentiation between the two columns within the dual column module 160 as well as the single column module 150, the columns will be referred to as, low, mid, and high-retentive separation columns. This is for example purposes only and for clarity in describing the system. Another example would be different polarity internal coatings in order to provide different separation selectivities. Additional coatings and combinations will be evident to those skilled in the art based upon the components being analyzed.

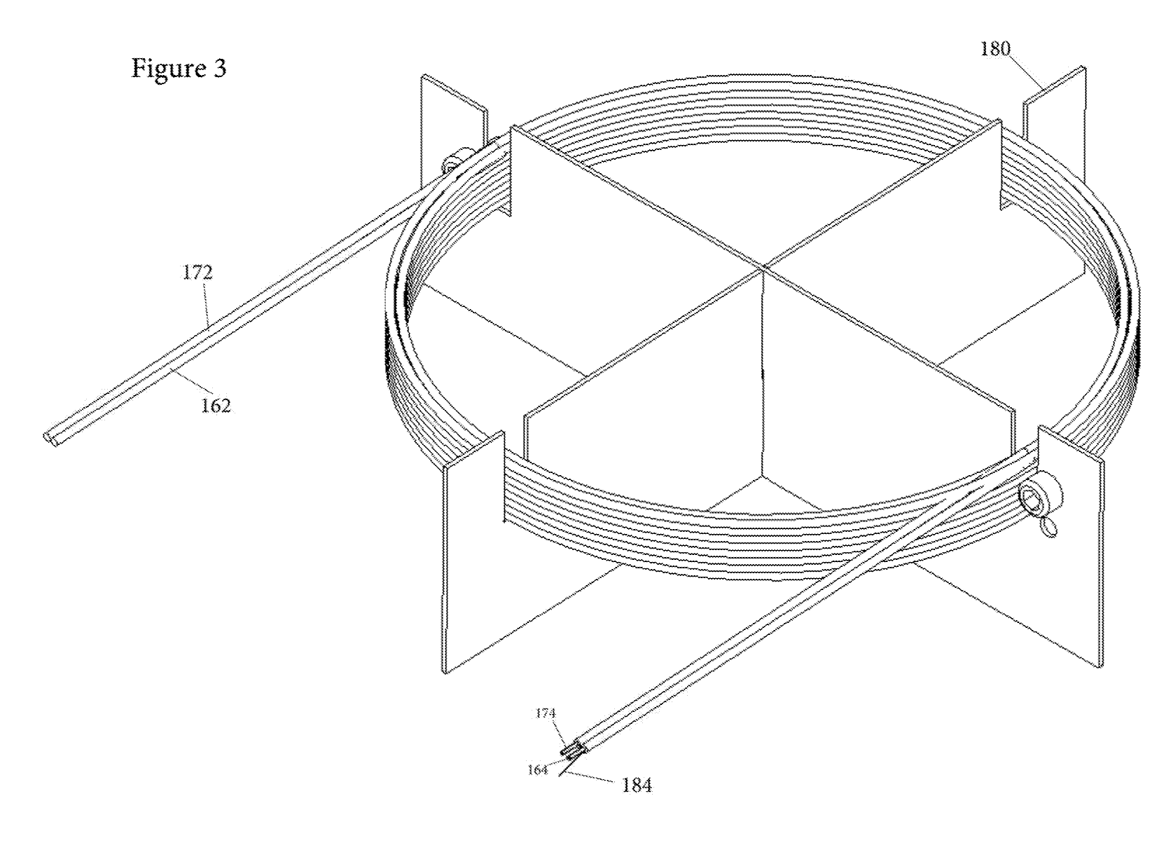

The dual column module 160 is unique in that it contains both the mid-retentive separation first column 162 and high-retentive separation second column 172 wrapped together on the single support ring 182 as illustrated in FIGS. 3 and 6. It should be noted that the support ring 182 onto which the columns 162 and 172 are wound is not illustrated in FIG. 3 to more clearly illustrate the placement of the dual columns 162 and 172.

The mid-retentive first column 162 can be used to separate light hydrocarbons in the range of about n-C2 to n-C12. The high-retentive second column 172 can be used to separate the permanent gases consisting of hydrogen, oxygen, nitrogen, methane, carbon monoxide, and carbon dioxide.

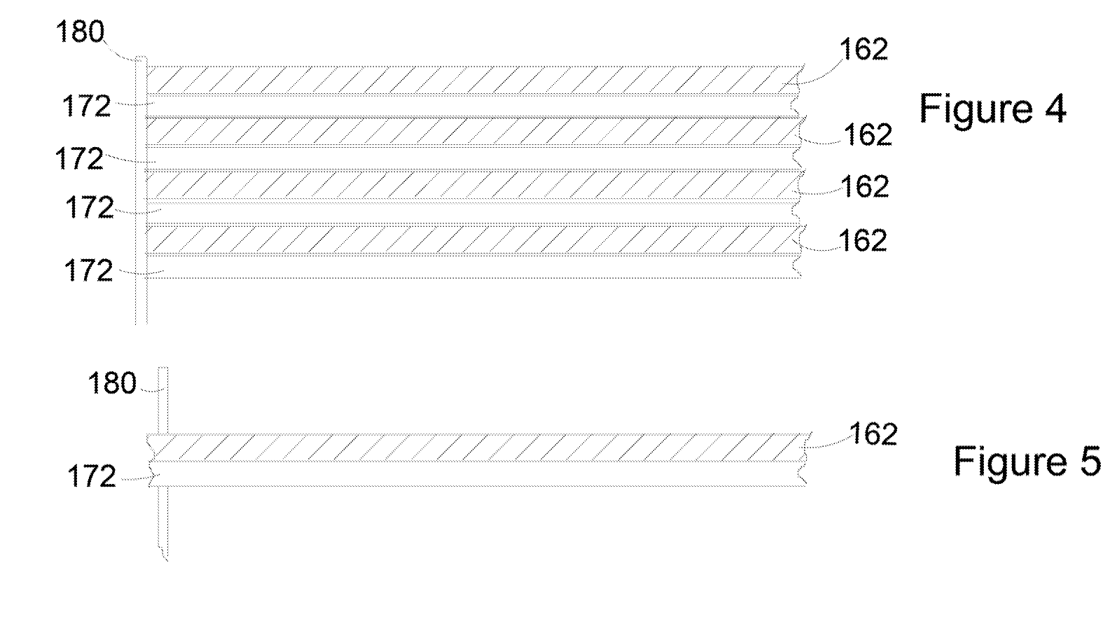

The mid-retentive first column 162 and high-retentive second column 172 can either be wrapped together side by side on the ring (FIG. 4) or alternatively one can be wrapped fully on the ring and the other directly on top (FIGS. 3 and 5). The ultimate goal is to have both columns 162 and 172 in direct contact with each other along their entire lengths, excluding the inlet leads 166 and 176 and outlet leads 164 and 174 portions of their respective columns 162 and 172. The outlet leads 164 and 174 leave the ring 182 for attachment to the mid-retentive separation first column 162 outlet port 202 and high-retentive separation second column 172 outlet port 206 where they are in communication with the remainder of the system 100. The components are received through column 162 and column 172 inlet ports 204 and 208 respectively, which are in communication with inlet leads 166 and 176. The inlet ports 204, 208 and outlet ports 202, 206 are contained inside the isothermal oven 104. As the mid-retentive separation first column 162 and high-retentive separation second column 172 operate independently, each must have separate inlet and outlet ports.

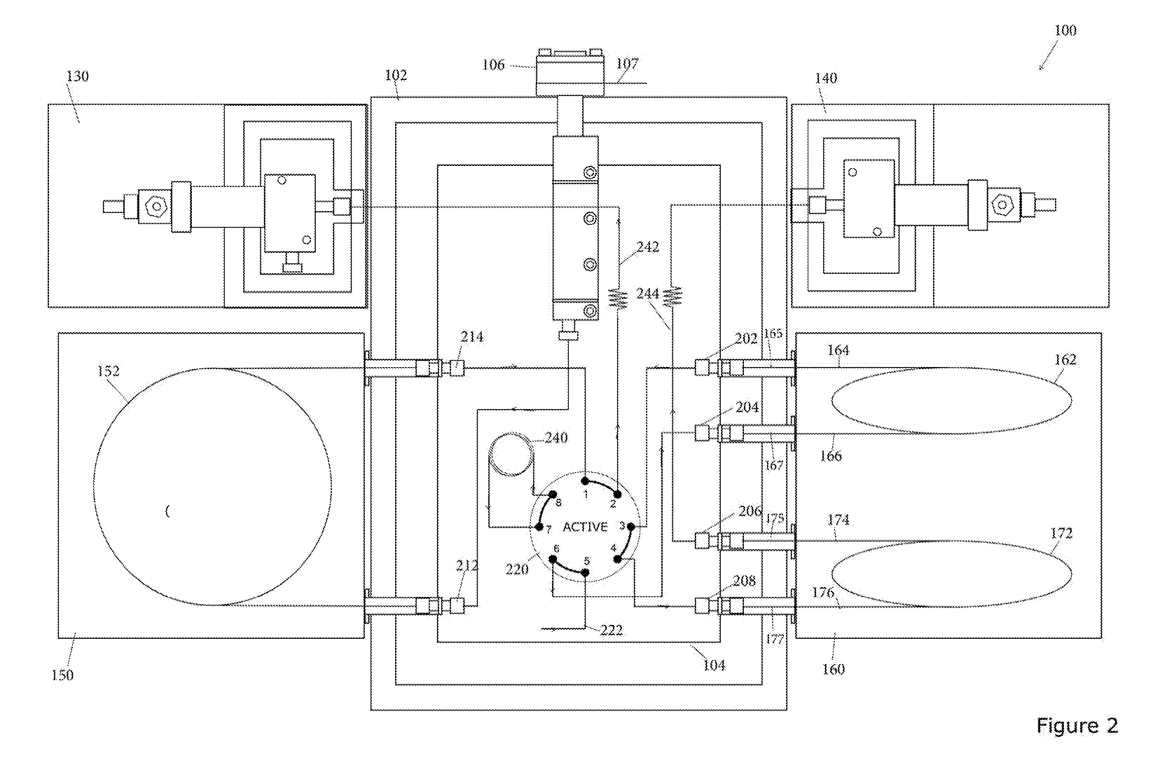

As illustrated in FIGS. 1 and 2, mid-retentive separation first column 162 receives samples from inlet port 204, through inlet lead 166 and after elution sends the samples, through outlet lead 164, to outlet port 202. Samples are transferred into high-retentive separation second column 172, through inlet lead 176 from inlet port 208 and, after elution, through outlet lead 174 to outlet port 206.

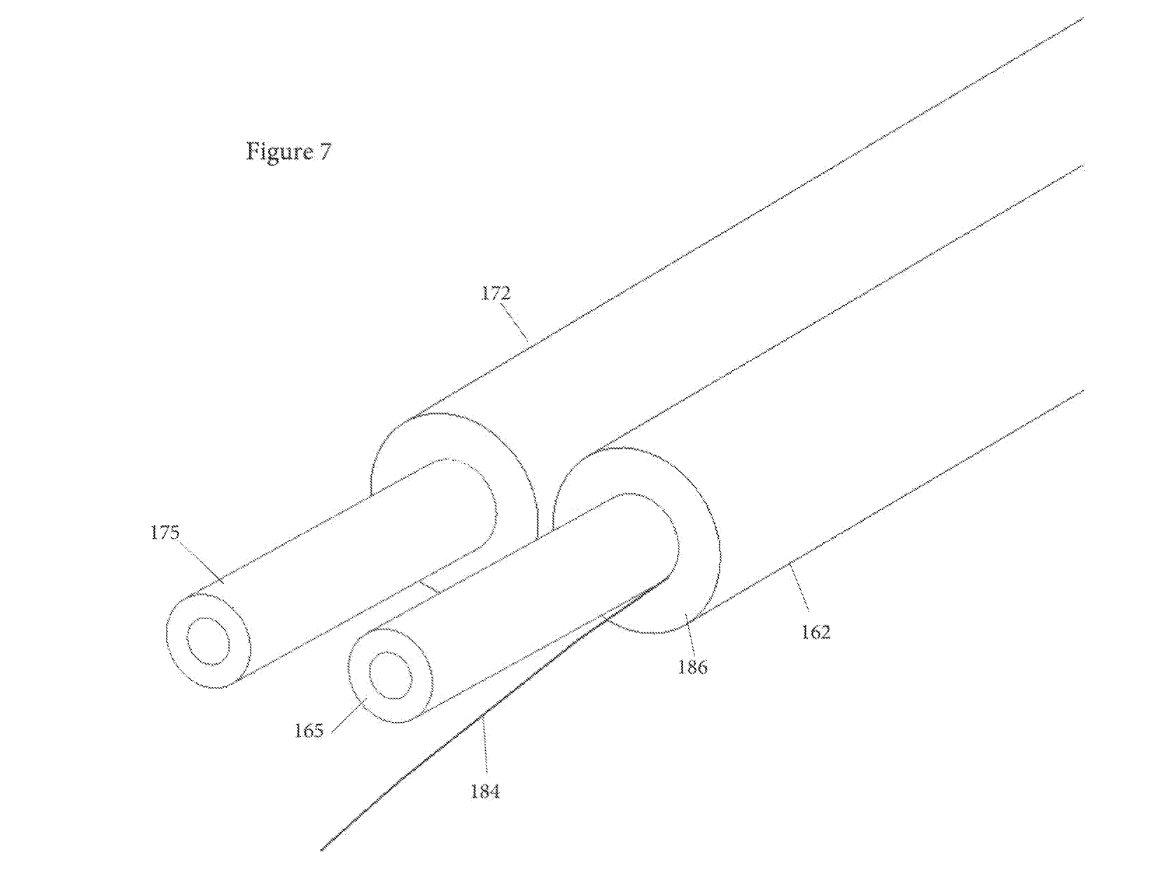

With the sheathed dual columns 162 and 172 tightly and compactly coiled adjacent one another on the conductive support ring 182, surface area is reduced along the entire length of the columns 162 and 172. The support ring 182 can be constructed of any thin metal; however, it is beneficial to have it made of a highly conductive metal in order to quickly distribute heat evenly across the entire length of the wrapped column material. The first benefit to this is the reduction of convective heat losses and consequently the power required to heat, for example, the mid-retentive separation column 162. However, the column leads 164, 166 and 174, 176 of the sheathed columns 162 and 172 that are not wrapped on the conductive support ring 182 (FIG. 6) have a much larger surface area of column material exposed to free convection that results in a lower temperature profile relative to the coiled main body of the column material. To alleviate this problem a heater circuit as discussed in U.S. Pat. No. 8,414,832 connects in parallel with the microprocessor controlling the single column module 150 and the dual column module 160. In this embodiment, an RTD sensor wire 184 (FIG. 7) is placed between the uninsulated metal column capillary and the sheathing 186 to provide feedback as to the temperature of columns 162, and 172. Embodiments benefiting from RTD sensor wires placed in both columns 162 and 172 will be evident to those skilled in the art. Since the temperature of the coiled main column body is actively controlled and the end heater coils are operated passively in parallel, the power dissipated in the end heater coils is proportional to the power dissipated in the main column body based on the total resistance of the end heater circuit, which includes a series combination of both heater coils and the optional power resistor. The optimal total series resistance of the end heater circuit was experimentally determined based on a balance of having sufficient heat dissipated in the column inlet leads 166, 176 and outlet leads 164, 174 at a minimum linear heating ramp rate while not overheating the column inlet leads 166, 176 and outlet leads 164, 174 at a maximum linear heating ramp rate. Chromatographic runs were performed at minimum and maximum linear heating ramp rates with various values of extra resistance in the power resistor and then analyzed to determine the optimal total resistance value for the end heater circuit.

The construction of the coil 152 in single column module 150 is the same as that of the coils 162 and 172 in dual column module 160 as far as column coiling, sheathing, end heater coils, sensor wire etc. The only difference between the single column module 150 and dual column module 160 is that only one single column 152 is wrapped on the ring.

The dual column module 160 is also unique in that the system provides the option that only one column is directly resistively heated and contains the temperature feedback RTD element 184, providing a second benefit. In the illustrated embodiment the column capillary is a stainless steel tube with a coated inner surface. Controlled current is applied to the stainless steel tube that then self-heats the column, with the sensor wire 184 providing temperature control feedback. Alternatively, both the mid-retentive separation column 162 and the high-retentive separation column 172 can be heated in parallel for faster temperature programming. The simultaneous or alternating heating of the columns will be based on the application and will be known to those skilled in the art. For illustration purposes only, mid-retentive separation first column 162 is labeled as having being resistively heated while high-retentive separation second column 172 is passively heated by its proximity to the mid-retentive separation column 162. Both columns 162 and 172 by default will be temperature programmed at the same time and compatible final temperatures for use in the separation of the two groups of components (permanent gases and light hydrocarbons). However, as noted above, both columns can be heated simultaneously by applying current to both columns in parallel.

The multi-port chromatographic switching valve 220 (CS valve) contained in the sample processing module 102 is of any variety known in the art capable of withstanding temperatures greater than 150° C., has low internal volume, can be switched from an idle state (FIG. 1) to an active state (FIG. 2) in less than 100 ms and has chemically inert internal passage ways. Typical vendors for such valves include Valco Instruments Co. and Analytical Flow Products. These valves can be of the simple rotary style or diaphragm style.

All tubing for fluid communication between the sample inlet 106, single column module 150, dual column module 160, detector module 130, detector module 140, and all ports on the CS Valve 220 are either deactivated fused silica or deactivated stainless steel capillary tubing commonly available from chromatography suppliers such as Restek. The sample loop 240 as shown in FIGS. 1 and 2 represents a fixed length of deactivated tubing as described above with a volume defined as described below in the operational example. As noted hereinafter the sample loop 240 is used to temporarily hold the sample for transfer from the single column module 150 to the dual column module 160 and is a length of deactivated capillary tubing. The flow restrictors 242 and 244 are also fixed lengths of deactivated capillary tubing having a diameter dimensioned to create a restricted flow rate of carrier gas. The interior diameter of each of the flow restrictors 242 and 244 is specific for each column to which it is attached for a given pre-set system pressure. Single column 152 and the mid-retentive first column 162 share flow restrictor 242 directed to detector module 130.

The high-retentive second column 172 uses a separate flow restrictor 244 and is directed to detector module 140. In this particular example, because the high retentive column 172 is of the micro packed variety, it provides its own resistance to flow internally and would not need a very large flow restrictor relative to single column module 150 or the mid-retentive column 162 since both of these are essentially open tubular columns with much less internal flow resistance.

The foregoing is an example combination of possible combinations. Alternatively, the highly retentive column could also be an open tubular type column, in which case it would require a larger flow restrictor (longer or small internal diameter) to limit the flow rate to that similar to the other two columns. The low and mid retentive columns could both be micro packed or a combination of open tubular and micro packed.

The sample introduction to the system occurs at the sample inlet 106. The inlet 106 can be a split/splitless design, direct on-column design, or a programmed temperature vaporizer (PTV) design, and can also be fitted with a multi-port sample loop style injection valve used to inject either gas phase or liquid phase samples. All of these are well known and commonly used in the art for sample introduction.

Carrier gas is input directly into the sample inlet 106 at gas input 107 and directly into the CS valve 220 port 5 at gas input 222. The gas source exists outside of the system and is well known in the chromatographic art.

### Preferred Embodiment

### Operational Example

In the operational example below, the system consists of the following modules and components:

Detector module 130—flame ionization detector (FID) for detection of ˜n-C2 to n-C44 hydrocarbons.

Detector module 140—thermal conductivity detector (TCD) for detection of permanent gases that do not respond on the FID.

Single column module 150 containing:

Low-retentive separation column 152 4 m, MXT-1 320 um ID, 0.2 um df (From Restek, for the separation of ˜n-C5 to n-C44)

Dual column module 160 containing:

Mid-retentive separation column 162-2 m, MXT Q-bond, 320 um ID, 10 um layer (From Restek, for the separation of ˜n-C2 to n-C6)

High-retentive separation column 172-2 m, Shincarbon, 530 um ID, micro packed, 100/120 mesh (From Restek, for the separation of hydrogen, oxygen, nitrogen, methane, carbon monoxide and carbon dioxide)

CS Valve 220—8 port, 2 position, high temp, 1/32″ fitting rotary valve (From Valco)

Inlet 106—Split/splitless with glass liner, fitted with a high pressure (<=5000 psi), 100 nL, rotary, liquid inject valve (From Valco)

This example uses a high pressure, liquid crude petroleum sample which can contain components as light as hydrogen, up to and beyond n-C44 in molecular weight. The system will essentially fractionate the sample into three distinct groups of molecules that will get separated or one of the three columns and then diverted to either detector module 130 (for example a FID) or detector module 140 (for example a TCD) for quantitation.

As in all gas chromatographs, there is a flow of carrier gas from a controlled source of pressure that is continuously flowing into the inlet 106 near the top and out the bottom to the single column 150 column inlet port 212. The system 100 as disclosed also contains a secondary source of carrier gas pressure 222 that is connected to port 5 on the CS Valve 220 which provides carrier gas for the second column 172 of the dual column module 160 while the CS Valve 220 is in the idle state as illustrated in FIG. 1.

100 nL of sample is injected into the hot (˜340° C.) inlet 106 from a rotary liquid inject valve where it is immediately vaporized inside the glass liner of the inlet 106.

Carrier gas flow 107 sweeps the homogenous sample vapors from the glass liner to the inlet port 212 of single column module 150 leading to single column 152 via a deactivated small diameter capillary tube, in this example <530 um ID.

The sample vapors enter single column 152 which is held at a relatively cool temperature of 40° C.

Due to the cool temperature of the single column 152, all components greater than ˜n-C10 immediately condense back to a liquid and are deposited on the inner surface of the single column 152. The permanent gases and light hydrocarbons, up to ˜n-C4, continue to move through the single column 152, mostly unseparated, to the outlet port 214. From the outlet port 214 the components enter the CS valve 220 at port 1 and exit at port 8 to the sample loop 240. A slight separation between n-C4 and the C5 hydrocarbons will develop.

As soon as the mostly unseparated sample vapors of hydrogen to n-C4 have entered the sample loop 240 between ports 7 and 8 as shown in FIG. 1, the CS Valve 220 is switched to its active state (FIG. 2) thereby trapping the hydrogen to n-C4 fraction inside the sample loop 240. As the sample loop 240 is used to temporarily store the components, the internal volume of the sample loop 240 must be sized to hold the entire volume of the hydrogen to n-C4 vapor band. The volume of the sample loop 240 is dependent upon the sizing of the system and components being tested. The adjustment of the sample loop volume will be evident to those skilled in the art.

With the CS Valve 220 in the active state, single column 152 is now temperature programmed to elute the ˜n-C5 to n-C44 fraction through port 2 to the flow restrictor 242 and on to the FID within detector module 130 for component quantitation.

When this elution in single column 152 has finished, the column begins cooling. When single column 152 has reached a sufficiently cool temperature that is generating no column bleed (usually around 200° C.), the CS Valve 220 is switched back to its idle state (FIG. 1) which immediately sends the contents of the sample loop 240 into the CS valve via port 7 and out of the CS valve via port 6 to the inlet port 204 of the dual column module, through inlet lead 166, and into the mid-retentive first column 162 contained in dual column module 160.

After the contents of the sample loop 240 have been completely loaded into the mid-retentive column 162, the CS Valve 220 is once again switched to the active state (FIG. 2). This connects the outlet port 202 of the mid-retentive first column 162 at port 3 of the CS Valve 220 to the inlet port 208 of the high-retentive separation second column 172 through port 4 of the CS Valve 220.

With the mid-retentive separation first column 162 temperature at ˜40° C., the loaded components begin to separate as they move along its length. The first components to elute from the mid-retentive separation column 162 will be hydrogen, oxygen, nitrogen, carbon monoxide, methane and carbon dioxide. These components have very low retention on the mid-retentive separation column 162 and consequently will elute from the column 162 as nearly a single peak with some possible slight separation between methane and carbon dioxide. Because of the desire to have full separation between these components, they are transferred to the high-retentive separation column 172 which does have the retention necessary for separation.

The CS Valve 220 remains in the active state until the final component, or permanent gases, required for separation on the high-retentive separation column 172 (in this example, carbon dioxide) leaves the mid-retentive separation column 162, entering at port 3, and exits port 4 on the CS Valve 220. At this time the CS Valve 220 is returned to its idle position. The switching of the CS Valve 220 to idle upon removal of the permanent gases is based upon time as determined from previous trials.

It should be noted at this point that because all components moved to the high-retentive separation second column 172 in this example, with the exception of methane, are not hydrocarbons, they do not generate a response on a FID. A TCD is therefore used for detector module 140 and is connected to the outlet port 206 of the high-retentive separation second column 172 in order for quantitation of these components to be performed.

With the CS Valve 220 now in the idle state, dual column module 160 begins its temperature program, actively heating mid-retentive column 162, thereby heating both columns simultaneously. Both the mid-retentive separation column 162 and the high-retentive separation column 172 are plumbed with their own separate carrier gas supplies. For the mid-retentive separation column 162, it receives its carrier gas from carrier gas supply 107 through the sample inlet 106, through column module 150, through the sample loop 240 via ports 1 and 8 and ports 7 and 6 on the CS valve 220. The high-retentive second column 172 receives its carrier gas from carrier gas source 222 via ports 4 and 5 of the CS valve 220. The outlet ports from columns 162 and 172 have independent flow paths to different detectors enabling essentially parallel operation.

When the final component elutes from either the mid-retentive separation column 162 or the high-retentive separation column 172 the system enters the clean out phase. As the two columns 162 and 172 are operating in parallel, which ever column elutes its final component last will determine when the separation of the sample is complete. Once separation is complete, the columns 162 and 172 are cleaned out by holding the column module temperature at its upper programmed value until any unwanted high-molecular weight residual material is eluted from both columns. Once cleaned, the dual column module 160 enters its cool down phase and returns to its initial set point. This concludes a full cycle for the system.

It should be noted that the dual column module can be used independently or a dual column module can replace the single column module. The configuration of the modules, detectors, etc. would be dependent upon the sample. Additionally, in situations where the analysis of the permanent gases is not required, the separation can end at the mid-retentive column. The configuration of a system to accommodate these and other examples will be evident to those skilled in the art in conjunction with the instant disclosure.

It should be noted that this is an example process and that other samples being eluted can have different flows and timing. The timing throughout is controlled by the microprocessor and, without the incorporation of sensors within the system, is based on past runs.

The primary advantage of the disclosed system is the use of the dual column module containing two individual separation columns co-located on a single mounting ring. Each are able to individually analyze components and along with the single column module this expands the molecular weight range of components that could normally be separated and quantified in a single sample injection. Also, each separation column has the ability to be temperature programmed rather than residing in an isothermal oven. This significantly reduces the overall cycle time requirement for the analysis.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 10%.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1) A chromatographic system for rapid analysis of fluid components having a wide molecular range in a single sample having:
a. an isothermal oven, said isothermal oven comprising:
i. a sample inlet;
ii. a switching valve, said switching valve having multiple ports, an active state, and an inactive state; and
iii. fluid communication members;
iv. a carrier gas inlet;
b. a single column module, said single column module comprising:
i. a single column, said single column having sheathing along a majority of its length and an unsheathed section at each end;
ii. single inlet port, said single inlet port in fluid communication with said single column and said sample inlet;
iii. single outlet port said single outlet port in fluid communication with said single column and said switching valve;
c. a first detector module, said first detector module in fluid communication with said switching valve;
d. a second detector module (140);
e. a dual column module (180), said column module (160) comprising:
i. a second column (162);
ii. a second inlet port (204), said second inlet port in fluid communication with said second column and said switching valve;
iii. a second outlet port (202), said second outlet port in fluid communication with said second column and said switching valve;
iv. a third column (172);
v. a third inlet port (208), said third inlet port in fluid communication with said third column and switching valve;
vi. a third outlet port (206), said third outlet port in fluid communication with said third column and said second detector module (140);
f. a sample loop, said sample loop in fluid communication with said switching valve;
wherein said switching valve controls fluid flow between said first column module, said second column module, said first detector module, and said second detector module.

2. The chromatographic system of claim 1 wherein said second column and said third column are wound on a single ring adjacent to one another.

3. The chromatographic system of claim 1 wherein said second column is heated and said third column unheated column, said heated column passively heating said, unheated column.

4. The chromatographic system of claim 3 further comprising a sensor wire proximate said heated column.

5. The chromatographic system of claim 2 wherein each of said first column, said second column and said third column have predetermined retention times for said fluid.

6. The chromatographic system of claim 1 wherein said fluid is transferred to said sample loop to be retained for a predetermined period of time between said first columns and said second column, said switching valve controlling said transfer.

7. The chromatographic system of claim 1 further comprising a microprocessor having software to control said switching valve and temperature of each of said columns.

8. The chromatographic system of claim 1 further comprising a second carrier gas input connected to said switching valve to move said sample through said third column.

9. The chromatographic system of claim 1 wherein said fluid communication members further comprise flow restrictors.

10. The chromatographic system of claim 1 wherein said second column and said third column are heated.

11. The chromatographic system of claim 10 where at least one of said second column and said third column have a sensor wire.

12. A chromatographic column module comprising:
a first column;
a second column;
a ring;
wherein said first column and said second column are wrapped around said ring adjacent one another, each of said first column and said second column having input and output ports for individual analysis.

13. The chromatographic column module of claim 12 wherein said first column is heated and said second column is passively heated by said first column.

14. The chromatographic column of claim 13 further comprising a heat sensor in said first column.

15. The chromatographic column module of claim 12 wherein said first column and said second columns are heated.

16. The chromatographic column module of claim 15 wherein at least one of said first column and said second column contain a heat sensor.

17. The chromatographic column module of claim 12 further comprising an isothermal oven module having a sample inlet, fluid communication members and a multiport switching valve, said input and output ports being in fluid communication with said sample inlet and said switching valve.

18. The chromatographic column module of claim 17 further comprising a detector module, said detector module receiving eluted sample from at least one of said first column and said second column.

19. The chromatographic column module of claim 17 further comprising a second column module having a third column and input and output ports, said input and output ports being in fluid communication with said sample inlet and said switching valve.

20. The chromatographic column module of claim 17 further comprising a second detector module, said second detector module being in fluid communication with said switching valve.

21. The method of analyzing components having a wide range of molecular weight in single sample comprising the steps of:
placing a switching valve in an isothermal oven to an idle state;
placing said sample in a heated sample inlet having a carrier gas and vaporizing said sample;
transferring said sample through a fluid communication member to an input port of a cool first column for elution;
transferring said sample, after elution, to a first column output port, a portion of said sample remaining in said first column;
transferring said sample through a fluid communication member to a first port in a switching valve;
transferring said sample from said switching valve to a sample loop:
switching said switching valve to an active state;
transferring said portion of said sample in said first column through said switching valve to a first detector module;
switching said switching valve to an idle state and transferring said sample in said sample loop to a second column within a dual column module, said second column being adjacent to a third column, and wrapped on a single ring;
switching said switching valve to an active state to transfer permanent gases to said third column;
switching said switching valve to an idle state and actively heating said second column and said third column to complete elution
transferring components in said second column and said third column to a first and a second detector module based on components;
heating said second column and said third column to clean out residual material.
